(19) United States
(12) Patent Application Publication
(10) Pub. No.: US 2022/0245548 A1
(43) Pub. Date: Aug. 4, 2022

(54) INNOVATION PROCESS

(71) Applicant: Maher G. MEZHER, Hazmieh (LB)

(72) Inventor: Maher G. MEZHER, Hazmieh (LB)

(21) Appl. No.: 17/432,855

(22) PCT Filed: Feb. 21, 2020
(86) PCT No.: PCT/IB2020/051453

§ 371 Date: Aug. 20, 2021

Related U.S. Application Data
(60) Provisional application No. 62/809,582, filed on Feb. 23, 2019.

(51) Int. Cl. G06Q 10/06

(52) U.S. Cl. CPC G06Q 10/06315; G06Q 10/06375

(57) ABSTRACT

The present invention relates to ideation management for an innovation process which enables users to transform their creative ideas into profitable innovations. The system and method of the present invention discloses an innovator process wherein said process provides for an interactive and interconnected tool and device as well as an innovative system for generating innovations within organizations. The system and method of the present invention aims to accelerate a user's creativity & innovation while providing him/her with a detailed feasibility study & plan of action taking into consideration the experience & knowledge of said user. The present system and method engage a user through the use of the disclosed devices and tools triggering different parts of the brain and the different senses.

### BACKGROUND OF THE INVENTION

### Field of the Invention

The present invention relates generally to information management and more particularly to ideation management and a system and method for creating, recognizing and identifying innovative ideas within individuals and organizations. The proposed system and process also provision for the capturing, storing, and accessing information used during the innovation of a product, service, process, event, brand, network, structure, strategy, project or even a business.

### Background of the Invention

It is a very well-known fact that individuals, organizations and governments which succeed and maintain continuity are constantly innovating their products, services process, event, strategy, project, brand, network, structure or even business model. Successful organizations are those who constantly grow their capabilities and are innovating in their thinking and ideas.

Organizations tend to invest in a number of processes such Human Resources, Information Technology, Customer Relationship, Management and Leadership, etc. For organizations with Research & Development, innovation is considered as a part of the goals and objectives of such a department. However, even such organizations do not have company-wide innovation processes & tools enabling possibly each and every employee from being innovative and contributing to the company's innovation objectives.

Innovation within an organization does not necessarily need to be limited to the company's core business. Organizations generally are compartmentalized into a number of departments, each of which is responsible for one or a few aspects of the business. The employees within these departments are themselves however exposed to the company's core business and may have the ability to contribute to the innovation process of the core business, or even any one of the many areas of operations in an organization.

A number of previously disclosed ideas address the problem of managing an idea from conception to the end of its life cycle. U.S. Pat. No. 6,944,514 (Matheson) discloses a system and method for capturing, storing and accessing information used during the innovation of a product in a tool neutral persistent form. Such a system may be used to capture an idea once it has been conceived and to allow its proper process and management through a series of steps and stages necessary in the life cycle of an idea.

U.S. Pat. No. 6,961,756 (Dilsaver et al.) relates to the submission and acceptance of suggestions. More particularly, the invention relates to an innovation network. Here again, the proposed system is for capturing an idea and processing it though the various stages of the life cycle of an idea.

U.S. Pat. No. 7,533,034 (Laurin et al.) relates to idea submission methods and computer systems for idea submission and development. The advantage proposed by Laurin et al. is to provide a cohesive system for formulating, reviewing, and implementing an idea.

Yet other disclosed prior art discuss various methods or systems for adequately managing an idea from conception, running it through a number of evaluation stages to determine its feasibility, viability, commercialization, as well as propose systems for feedback and development. None of the cited prior art, or others, propose a process and a system for enabling individuals or employees from generating the innovative ideas which will then be processed by the proposed methods and systems. The entire prior art require as a first input that an idea be available to be processed. The present invention discloses a process, method and a system which will enable its users, such as employees, employers or investors, to identify, extract innovative ideas & decide whether their idea is strong enough to be kicked-off in a most innovative process using sound or sonics as a key element for enabling the proposed system and method as well as using graphics or images for the same purpose.

### SUMMARY OF THE INVENTION

The present invention is a system and method for generating, capturing, storing, and accessing innovation information data. The invention provides an interactive portal which enables users to clearly define an idea and develop it into an invention. The purpose of the process and system of the present invention is to transform individuals and organizations into innovation drivers and enable them to readily identify and put to execution innovative ideas.

The computer-enabled process uses a system which interacts with the user's responses to specific stimuli, such as for example sound and sight, to help them recognize and generate creative ideas. The stimuli generated are not random; rather they are based on a vetted algorithm. The system utilizes a four-step innovators process that helps users to unlock their imagination, define and develop potential ideas, assess and evaluate these ideas and launch the selected ideas.

In an unexpected yet anticipated outcome, the present invention engages users by utilizing two senses not previously utilized in such processes, namely sound and sight. It was found that use of these senses in addition to traditional methods affect the mindset of a user resulting in a much more efficient innovation process and outcome which necessitate computer-enabled program to deliver the necessary stimuli as well as capture the responses to said stimuli.

### BRIEF DESCRIPTION OF THE DRAWINGS

FIG. 1 is a schematic representation of the basic system of the present invention and the various components which enable the system and method therein.

FIG. 2 is a flowchart diagram representing the different steps through which a user goes from logging into the computer-implemented program to termination of a session or experience.

FIG. 3 is a diagram of the innovators process showing the four phases of said process grouped in two stages. In this embodiment, the first phase is what is defined hereinafter as the Unlock phase followed by the Define phase, the Assess phase and ending with the Launch phase. The first two phases together form the Ideation stage whereas the last two phases form the transformation stage.

FIG. 4 is a diagram of the innovators process, again showing the four phases of said process grouped in two stages. In this iteration of the process, the first two phases are inversed whereby the first phase is the Definition phase and the second phase is the Unlock phase.

FIG. 5 is a representation of a home screen or dashboard for initiating the process of an idea.

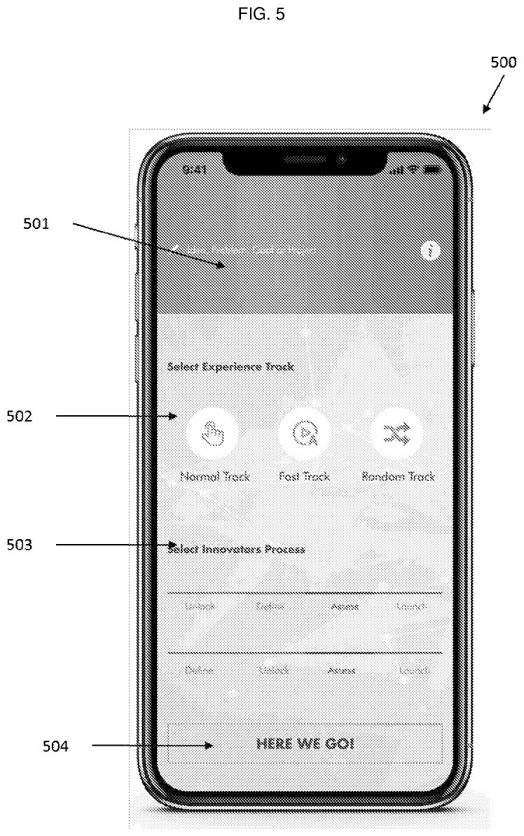

FIG. 6 is an example of a sample stimulus page during the innovation process.

FIG. 7 represents the four different stimuli used in the present invention in a funnel-shaped process.

### DETAILED DESCRIPTION OF THE INVENTION

The present invention discloses a computer-implemented system and method for an innovation tool and innovation process for generating and managing innovation for an individual and within an organization. The disclosed system and method may be enabled by use of a computer program on any device which allows such a system and method to be implemented, such as but not limited to a portable computer, a personal computer, a tablet or a smartphone.

The system and method, generally referred to as a system, may relate to providing an interface for innovation, and more particularly, but not exclusively, to providing an interface for enabling innovation processes within an organization. The principles described herein may be embodied in many different forms.

The system may provide an interface to one or more users within an organization. The interface may allow the users to create one or more ideas associated with an initial idea. The initial idea may be a topic or issue of relevance to the organization. The interface may also allow the users to rate the one or more ideas thus creating a ranking of importance of ideas for present or future evaluation. Certain ideas not possible to be invested in or developed at the present time can be in the future. the ability to identify such ideas and decide on the right time to trigger their implementation is critical.

The system may allow any number of ideas to be associated with the initial idea and/or with the other ideas, thereby allowing for multiple concurrent revisions of each initial idea. The system may provide an interface displaying a graphical representation of the ideas and the associations between the ideas to the users. The graphical representation may allow the users to easily determine where to add an additional idea to an existing idea. The system may order the ideas based on the ratings received for the ideas, and may display the ordered ideas to the creator of the initial idea. The creator of the initial idea may use the ordered list of ideas to efficiently determine the most valuable ideas associated with the initial idea.

The system may be applicable to any individual at all levels within a private or public organization as well as to independent entrepreneurs, investors or innovators looking to harness the power of ideation and to go beyond creativity alone.

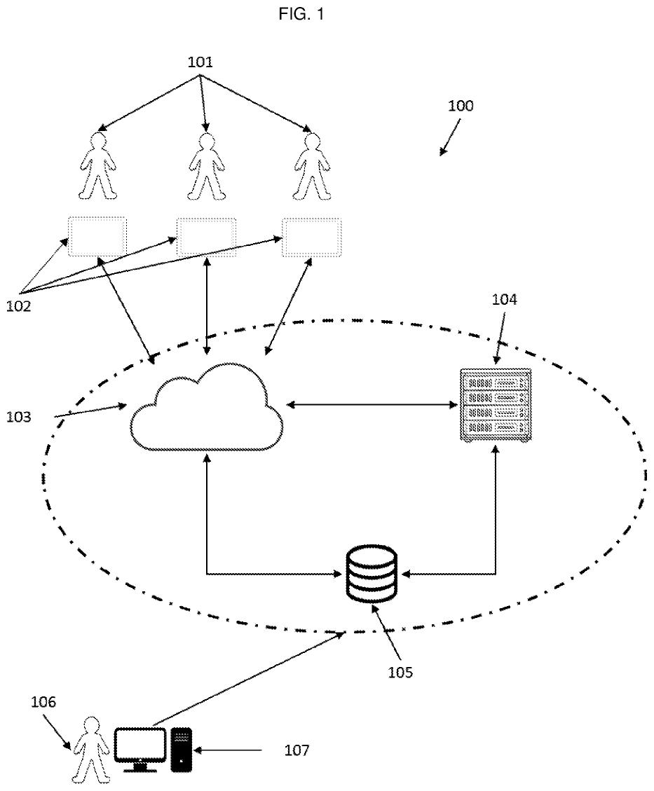

As sown in FIG. 1, the system 100 comprises multiple components including as described a user interfacing device represented by any computer such as a personal computer, portable computer, tablet or smartphone 102. The system 100 also comprises a digital network 103, a digital server 104 and a digital storage device 105. The system 100 enables inter-communication between the user interfacing device 102 and the network 103. The network 103 may be any currently existing or potential related technology and not merely limited to a network cloud as conveniently presented in FIG. 1 merely for illustration purposes.

Similarly, and also as shown in FIG. 1, the system 100 enables inter-communication between the network 103 and the server 104. In an embodiment of the present invention, these two components may have redundant activities or act as backup or recovery systems one to another.

Also an integral component of the proposed system 100 is a digital storage device 105 whereby the system 100 enables inter-communication between said storage device 105 and the network 103, or between the said storage device 105 and the server 104.

The system 100 is managed and controlled by an administrator 106 via a computing device 107 which connects and interacts with the following components of the system 100: the network 103; the server 104; and the storage device 105. The administrator 106 populates the server 104 and/or the network 103 with the computer-implemented program, maintains the same, initiates any necessary updates, fixes any errors and essentially manages the computer-implemented program and the good working of the system 100.

Users 101 accessing the system 100, via their computing devices 102 can download the computer implemented program from the network 103 or server 104 wherever it is made available to them. Once installed on the user's 101 computing device 102, the user 101 can launch and begin using the computer-implemented program and obtain access to the system and method of the present invention.

When a user 101 launches the computer-implemented program to utilize the system and method of the present invention, said user 101 may be prompted to create an account, which said account may be created and stored with its various parameters and credentials on the network 103 and/or server 104. On subsequent launches of the computer-implemented program, said user 101 may use the previously created login credentials or create a new account.

When creating a new account, the user 101 may be prompted to create a username and provide personal information such as a valid e-mail address, first name and last name, date of birth, gender, highest education level, industry, title, and other particulars deemed necessary for providing a better experience using the system and method of the present invention.

Once all requisite data has been entered, the user 101 proceeds to request the creation of a personalized account. Said user 101 may be notified to complete the account set-up via for example checking an automatically generated e-mail sent to the reported e-mail address to complete the account set-up process and create a dedicated password. In such case, a URL link will be provided in the said e-mail which will open a website page prompting the user 101 to create an acceptable secure password. Once created and approved for security, the user's 101 account will be created and stored as needed for future access permission and data mining.

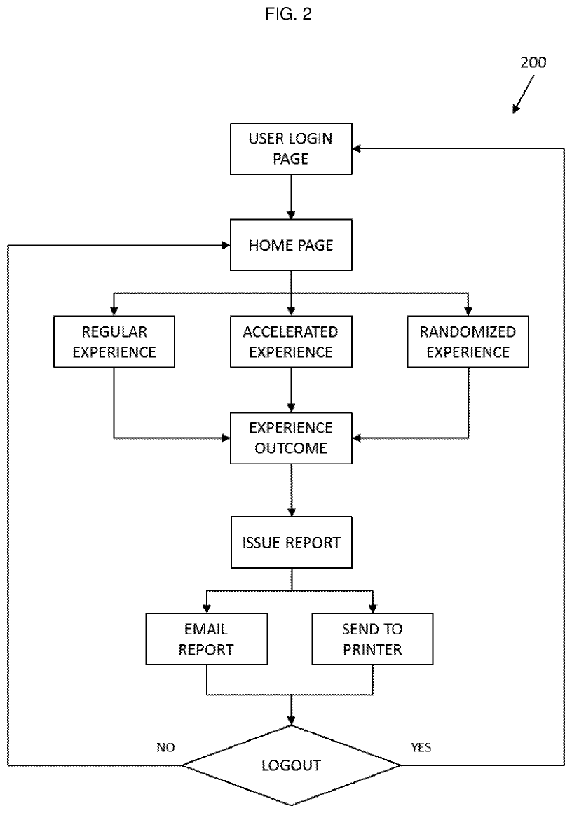

Armed with a newly created username and password, the user 101 may now access the innovator's experience tool by logging in with the registered credentials. In case of any typo or errors, the user 101 is notified or presented with the option to be reminded of the proper credentials. The steps for the innovator experience tool are shown in FIG. 2.

Upon logging in, a user 101 may be presented with a screen to choose between starting a new idea project or return to a previous one already started. In a key development to previous existing systems or methods, a sound, such as but not limited to a sonic, a jingle or a tune is played upon launching the tool. It is submitted herein that sound, and musical sounds, such as, but not limited to, a sonic, a jingle or a tune have bene found to affect the dopamine genes in a subject and hence affect said subject's mood. A number of scientific studies have been conducted to that end, studies which are not the subject of the present invention, but on which the present invention builds its unique and innovative system and method.

As a result of the research, experience and knowhow in the matters of music and sound, the use of a sound, such as, but not limited to, a sonic, a jingle or a tune positions a user of the present invention in a particular mindset, which if the correct sound is used, can uplift, motivate and engage said user, thus enhancing the outcome of the innovation process of the present system and method. This realization of the importance of sound as described herein above and in other parts of the present disclosure, led to the creation of the computer-implemented program of the present invention which will provide such adequately developed sounds at different stages of the innovation process to constantly and continuously place the user's mindset in the correct state to be innovative.

In a preferred embodiment, the sounds used throughout the innovation process and as performed by the computer-implemented program are between 1 to 10 seconds each and preferably less than 10 seconds in duration, each. The said sounds as described herein such as, but not limited to, a sonic, a jingle or a tune may be familiar ones taken from known composers or compositions; or specifically created for the purposes of empowering innovation in a user. It is submitted herein forth that the as a result of experience and know-how, the sounds played throughout the innovation process as provided via the computer-implemented system and method of the present invention, are specially designed defining the tonality, depth, pitch and decibels in order to specifically trigger the mindset of a user to be properly engaged by the specific innovation step or stage within the innovation process.

If the user chooses to start a new project, said user 101 may be directed to a home page screen or dashboard page 500 of the computer-implemented program of the present system and method. A specific sound as described herein before will play to set the user's mindset in the correct mood. The user 101 may be presented with an interface 500 which allows him/her to enter an idea 501, enter the place, time & mood, select the desired experience track 502 and indicate which one of the two optional proposed innovation processes 503 he/she wants to pursue before choosing to proceed 504 as well as possibly other key criteria which may be made available.

An important feature of the present invention is for the user to define in a few words or a sentence the idea he/she has 501. As a critical part of the innovation process of the system of the present invention is for the user to remain focused on the idea and not deviate from the main idea. The user may have the possibility of pursuing other ideas, interrelated or different, by restarting the process from the beginning. It is critical as an innovative aspect of the present invention that when a user lands on this page, that the adequate sonic has played, thus positioning the user's mindset in the best position for innovation.

The user then chooses the experience or track mode 502 depending on the need and setting and general experience with the innovation process of the present invention. The user then chooses the innovation process pathway 503 which is more suited to his/her idea. As a general guideline and for an improved experience never previously defined nor presented, the user innovation process pathway will be based on said user's idea background. It is generally known in the art and for people of ordinary skill that ideas emanate in one of two ways: either a novel idea pops suddenly in the head and is pursued; or an idea is built based on research and then pursued.

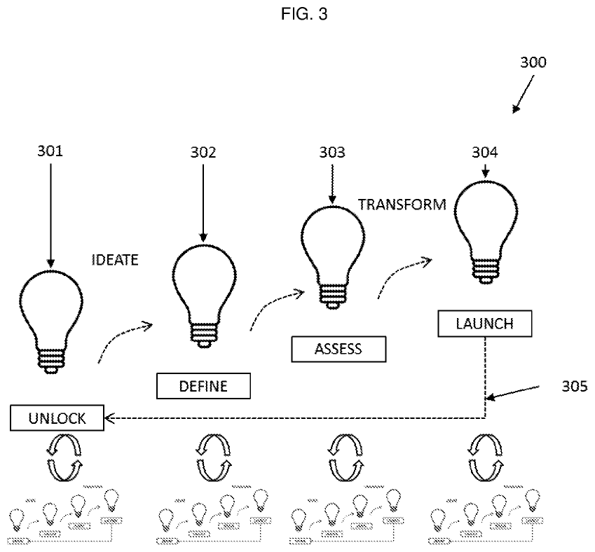

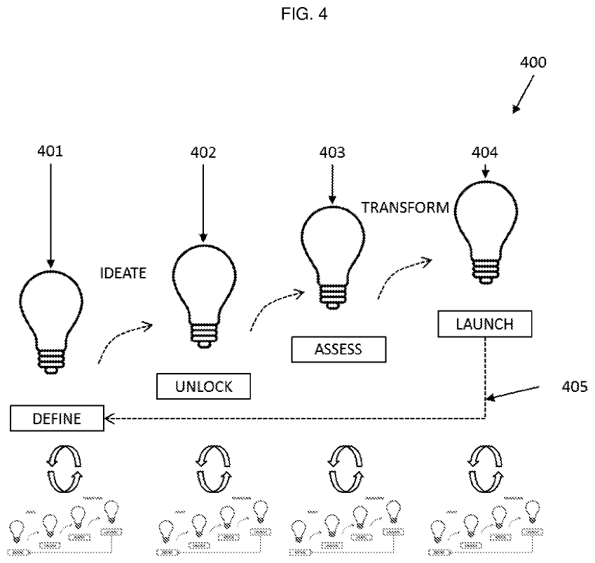

In the present innovation process, a unique feature of the present system which constitutes part of the basic novelty and innovative step of the present invention is the agility and ability to proceed with the innovation process based on the reason how the idea was obtained. The user is hence prompted to select between two distinct pathways or processes 503 which are shown as well in FIGS. 3 and 4 and to be selected.

As previously mentioned, the process of the system of the present invention is based on a simplified ideation and innovation technique that may be used in any industry and for users of any background, educational level, professional level and so on and so forth. The different steps in the pathway were vetted and developed to provide an innovative motivational and engaging experience to the user rather than a challenge. The steps of the innovation process are four, each elevating the user's idea to a higher stage of development and implementation of the idea as well as providing for the opportunity to continuously further innovate at each step and post launch of the product or process of the idea.

The Unlock step (301, 402) enables the user through an interaction with vetted stimuli to unlock the idea or solution which is floating in their mind but not yet fully materialized. This step further allows unlocking the opportunities of creativity to further develop the idea into a solution to a problem or need which triggered the idea in the first place. It is well known that creativity is present in every person's mind, however, structuring a creative idea in such a manner to be able to assess and capitalize on it is a feat only achieved by a small number who contribute to innovation within organizations or in the world in general. The step of unlocking the creativity and honing in onto an idea is critical and essential in any innovative process, however, until the process of the present invention has been developed, this critical step has been discounted and overlooked.

The Define step (302, 401) stimulates the user through another set of vetted stimuli to understand or define the particulars of the idea, the potential market, the industry(ies) it may cater to and the needs it addresses. At this step, the user is engaged to clearly define the problem the idea may solve, how and where.

The Assess step (303, 403) engages the user to evaluate other or existing solutions which may affect or enhance his/her idea. This step enables a user based on the idea's creation and definition to better gauge the marketability of said idea. Through a set of vetted stimuli, the user is challenged to define and understand the Key Performance Indicators (KPI). At this step of the process of the proposed invention, the user is engaged in elaborating typical measurement tools such SWOT and PESTEL analyses. The Assess step also provides the user with the ability to properly assess the barriers of entry or obstacles in general, risks, as well as evaluate the Return on investment (ROI), Return on Opportunity (ROO) and many other assessment & evaluation metrics. At this stage of the innovation process, an idea is given its expected value hence importance in an organization as a whole.

The Launch step (304, 404) can be subdivided into three sub-steps of pre-launch, launch and post-launch. It is sometimes, if not often, the case that great ideas fail to be launched or are delayed in launching as a result of poor preparation or planning due to certain obstacles. Such defects may cause loss of market share or poorer return and may even affect the feasibility and implementation of the idea. In the pre-launch sub-step, the user is engaged via vetted stimuli to adequately prepare for the launch by evaluating the needed budget, what to communicate and how in order to create or attract a market. In addition, this step of the present process engages the user to identify any legal, regulatory or other required authorizations in order to launch in a secure, uninterrupted and persistent manner. Once these are all identified and defined, the user can then execute on the launch of the idea and manage the idea through its desired life cycle. Successful ideas need to be constantly reviewed, evaluated and possibly refreshed. It is hence an important aspect of the present invention that after launch, the idea go through the same process as indicated by (305, 405) and the exercise and experience repeated to ensure the sustainability and continuity of the idea.

Throughout each step, the user experiences a pre-defined vetted number of stimuli including sound clips or sonics, short animations with sounds, quotes and questions. Each one of these is vetted to stimulate the user to dig into their creativity and experience to address the very many aspects of creating, defining and assessing an idea to ensure an adequate and profitable launch.

A key element for a user as he/she goes through the innovation process of the present application is to be in the correct mindset at each step or stage of the process. As described, when a user initiates a process using the computer-implemented program, a sonic plays to set him/her in the correct mindset for the complete process as well as at different steps or stages of the process. The computer-implemented program which enables a user to utilize the system and method of the present invention is essential as it enables the indispensable interaction necessary to stimulate and motivate said user to benefit fully from the innovation process and reach a successful launch.

Traditional and current innovation processes are based on a Q&A system which forces a user to focus on specific aspects of the process rather than expand his/her own creativity and successfully define and develop his/her idea. To the contrary of presently existing innovation processes, the present system capitalizes on a user's full capacity by guiding him/her through the innovation process using scientifically proven theories and principles for expanding a subject's creative capabilities and thought process.

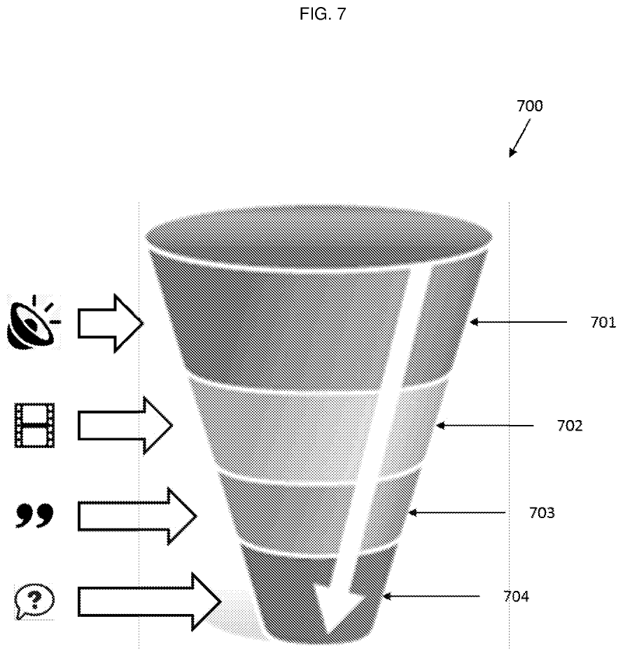

Throughout the innovation process of the present invention, a user is guided using four different types of stimuli with the objective of funneling said user's creativity and innovative capabilities from a very broad range of possibilities to narrowing down to the very specifics definitions and particulars of the innovation. As shown in FIG. 7, an innovative concept of the present invention, one which was never previously disclosed or practiced, is the use of different types of stimuli to motivate and engage a user for the specific step or stage of the process. The funnel-shape used in FIG. 7 is to indicate the mindset of a user which begins at its broadest with regards to a user-generated idea which through the proposed process of the present invention will be very specifically and clearly defined when exiting the funnel.

Studies have shown that music or sonics 701 provide for the broadest scope of creativity to a subject's brain. They enable the broadest visualization for a matter of interest. As such, when a user is stimulated with sound, his/her response is limited only by his/her imagination. This state of mind enables a user to stretch their imagination and think of an idea in the broadest of terms 701. In a preferred embodiment of the present invention, the duration of said music or sonic is between 1 and 10 seconds, or preferably between 1 and 5 seconds, and in all cases, preferably not less than 3 seconds.

The next step in the funneling process 700 is the visual animation 702 which combines both sound and image. The addition of the visual animation to the sound at this stage is a vetted procedure for narrowing down the field of imagination thus enabling a user to narrow down the scope of an idea by defining certain elements which are triggered by the short animation. The mindset here shifts gears and a user is forced to choose and decide on specific elements from the earlier broadest step of sound alone.

Further guiding a user down the funnel 700 to narrow down and describe the various elements of an idea are quotes 703. Shifting gears and the mindset of a user, this step of the process whereby a user is stimulated by specifically vetted and chosen quotes, engages said user to start focusing on the things that matters most for the development and implementation of an idea. Still at this part of the process of the present invention, a user is not being forced to limit an idea based on predefined guidelines. At the quote step, a user is still empowered to interpret and respond to these stimuli in different ways, yet limiting the responses to focus on further defining the elements which were selected and narrowed down by the two preceding steps of sound 701 and animation 702.

Finally, to closely describe a plan or strategy for implementation of an idea and convert the previously defined elements using the steps of sound 701, animation 702 and quotes 703, a user is challenged with a set of direct questions 704 which will define actionable items and specific goals and objectives for each. At the completion of the steps represented by the funnel 700, a user has clear definitions and details of an idea.

This funnel 700 process is implemented at every one of the steps of the innovation process of the present invention, namely, Unlock, Define, Assess and Launch. Well vetted and defined sounds or sonics, animations, quotes and questions are provided to position and enable a user's brain capabilities to convert any idea into a commercial or profitable idea.

The process of the present invention also has the ability to help a user determine whether an idea can or cannot be implemented, is or is not commercializable. Since ideas require investments, one of the aspects of the present innovation propose is to enable users to determine which ideas should be pursued and which should be abandoned, or possibly developed further. For an organization, such ability is a clear visibility on return on investments and return on opportunities.

In a preferred embodiment of the present invention, and based on knowhow and expertise, it is submitted herein that the importance of sound via a sonic, jingle or tune is embedded throughout the innovation process for a user developing an idea to constantly be placed in the correct mindset. As described herein above, a sonic plays once a user launches an innovation process. Said sonic is specifically created to have a pre-defined tonality, depth, decibels and pitch so as to engage said user by setting his/her mindset in an appropriate state. It is hence a preferred embodiment for the present system to play a sonic at different stages such as, but not limited to, the transition between the ideation stage (301-302, or 401-402) to shift a user's mindset from the ideation mood to the transformation mood. It is submitted herein that this addition of a sound at this stage has never been proposed, disclosed, used or even considered by individuals skilled in the art. It is further submitted that this addition can only be performed if the proposed system is a computer-based system.

It is further submitted herein that the proposed process, methods, systems, tools disclosed in the present system cannot have been achieved without very high level of knowledge and knowhow, combining expertise in music, innovation and marketing, and combing the various aspects in a computer-implemented program using specific devices and tools, both hardware and software, to enable this novel and innovative innovation process.

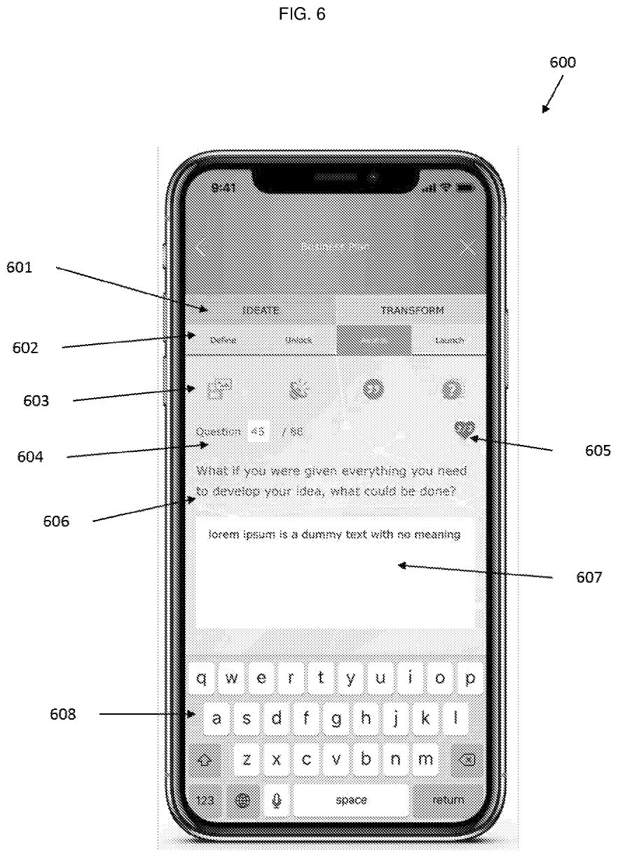

A screen shot of a landing page on the computer-implemented program installed on the device 102 of a user 101 constitutes part of the experience which will engage and enable a user to ideate and transform their idea into a marketed product or process. As an example of such a page, the system defines at which stage of the process 601 the user is, whether under the ideation or transformation stage. The page further defines at which step 602 of the innovation process the user is presently. As described above, the user is stimulated by one of four stimuli adequately highlighted on 603. In one embodiment of the present invention, the user may be engaged in responding to a number of stimuli, in this case as shown in FIG. 6, these add-up to 88 and the user is shown at which stimuli he/she is 604. The stimulus is shown on the screen 606 as a text, image, clip etc. depending on the stage and as previously described. The user is given a space 607 in which to input his reaction, thoughts or response to each stimulus and a method to input said reaction, thoughts or response, which in one embodiment and as shown in FIG. 6 is a keyboard 608.

An additional feature unique to the innovation process of the present disclosure is for a user to identify up to two responses to stimuli captured by 605. These chosen responses are made and recorded at 605 to indicate in each stage the two responses considered to be essential pillars for each step previously described, namely Unlock, Define, Assess and Launch. This method of identifying these pillars is known for a person skilled in the art as a diverging and converging technique.

While the stimuli are numerous and a list of which will not be disclosed here, we propose a few examples of vetted stimuli which may be included as part of the present process of the present invention but which are not to be construed as limiting or restrictive in any means or manner. An example extracted for each one of the different stimuli including a short video clip with sound, a short sound clip, a quote and a question.

Example 1—a short video clip with sound. Based on experience and know how, said short video clip with sound is developed to last between 1-10 seconds, preferably between 3-5 seconds. In a preferred embodiment, said short video clip with sound is about 3 seconds in time. A specific example is of a subject shown sleeping soundly on a bed in a bedroom. A dream bubble emerges and remains blank by the end of the clip. In this example, the user may be stimulated to dream about his/her idea and all the possibilities such a dream may result in. The short video clip with sound is intended to enable a specific thought process in the user to transform a creative idea into an ideation.

Example 2—a short sound clip. Based on experience and know how, said short video clip with sound is developed to last between 1-10 seconds, preferably between 3-5 seconds. In a preferred embodiment, said short video clip with sound is about 3 seconds in time. A specific example is the sound of a lion roar. A user may correlate his feelings, e.g. Fear, to his main idea and capture what are his fears that his idea or project will fail.

Example 3—a quote, made by a famous person or vetted to specifically trigger a unique stimulus or reaction from the user. The user will read the quote and get inspired then relate the meaning of the quote to his main idea taking into consideration the innovation process stage in order to capture his answer.

Example 4—a question, based on experience and know how, vetted to specifically trigger a unique stimulus or reaction from a user. A user will read the question taking into consideration his/her main idea and the innovation process stage to stimulate and formulate the best answer. A specific example is the following: “How might other industries inspire you?” Or “How will you monitor improvement?”

As an added unique feature which is enabled by the system and method of the present invention is a pop-up window which will engage the user by guiding a response. Said pop-up window, which may be considered as a hint window, will appear after a pre-determined period of time defined between the time a stimulus is initiated and the time a user starts responding based on one of the input mechanisms, i.e. typing, recording. Said pop-up is embedded in the system to clarify a stimulus in a form of a clear question giving a second chance to the user to come up with the best answer. As an example for the lion roaring sound clip, the pop-up window will prompt the user with “What are your fears?”

The description, specifics, embodiments and examples sued herein are mainly disclosed to describe the process of the present invention but are in no way to be considered as limiting as to the scope of the invention which will be further defined by the claims disclosed herein.

1. An innovation tool, comprising:
means for entering an innovative idea into a device;
an innovation process for defining and evaluating said idea;
means for completing a business plan for implementing said idea.

2. The innovation tool according to claim 1, wherein said idea may be a result of an observation or a creative idea.

3. The innovation tool according to claim 1, wherein said process comprises stimuli in the form of sound clips, animated images, quotes and questions.

4. The innovation tool according to claim 3, wherein said sound clips, animated images, quotes and questions are processed in that order.

5. The innovation tool according to claim 1, wherein said innovation process comprises the steps of:
playing a sonic to engage a user of said tool;
challenging said user with predefined stimuli comprising sound clips, animated images, quotes and questions, in that order;
allowing said user to input responses to stimuli into said device;
playing a sonic to engage said user between different stages of said innovation process;
allowing said user to highlight most important stimulus and related response, preferably not more than two from each step of said innovation process; and
allowing said user to review said responses or end said innovation process with another sonic playing to engage said user to implement on said business plan.

6. A method for generating and managing commercializable ideas comprising:
entering an idea into a database using a device;
selecting a requisite track and process;
inputting responses to predefined stimuli comprising sound clips, animated images, quotes and questions, in that order;
selecting important responses to their related stimuli; and
obtaining the outcome for the value of said idea and its implementation.

7. The method according to claim 6, wherein said device plays a sonic at defined times, preferably at the following stages: when said user launches the innovation tool; when the innovation tool first transitions into the predefined stimuli; when the innovation tool transitions between predefined stages; and when the user completes the innovation process of the innovation tool.

8. The method according to claim 6, wherein said user may input a response using any means available on said device.

9. The method according to claim 6, wherein said user is provided with hints if a response is not entered within a predefined period of time, wherein said period of time is between 5 to 10 seconds.

10. The method according to claim 6, wherein said method results in a business plan based on said innovative idea.
